(19) United States
(12) Patent Application Publication
(10) Pub. No.: US 2007/0058107 A1
(43) Pub. Date: Mar. 15, 2007

(54) Photoluminescent liquid crystal display

(76) Inventors: Seoung-jae Im, Seoul (KR); Byung-ki Kim, Gunpo-si (KR); Xiaoqing Zeng, Yongin-si (KR); Jae-young Choi, Suwon-si (KR)

Correspondence Address: CANTOR COLBURN, LLP, 55 GRIFFIN ROAD SOUTH, BLOOMFIELD, CT, 06002, US

(21) Appl. No.: 11/497,041

(22) Filed: Aug. 1, 2006

(30) Foreign Application Priority Data
Sep. 10, 2005 (KR) 10-2005-0084422

(51) Int. Cl. G02F 1/1335

(52) U.S. Cl. 349/71

(57) ABSTRACT

A photoluminescent liquid crystal display includes a lower substrate and an upper substrate disposed apart from each other opposite each other, a liquid crystal layer interposed between the lower and upper substrates, a backlight unit disposed under the lower substrate and emitting blue light, a phosphor layer disposed on the upper substrate and excited by the blue light and a color filter layer disposed on the phosphor layer and limiting excitement of the red and green phosphors by ambient light. The phosphor layer includes a red phosphor disposed in a red pixel region and a green phosphor disposed in a green pixel region. The color filter layer includes an R filter disposed on the red phosphor and a green filter disposed on the green phosphor.

This application claims priority to Korean Patent Application No. 10-2005-0084422, filed on Sep. 10, 2005 and all the benefits accruing therefrom under 35 U.S.C. §119, the contents of which is incorporated herein in its entirety by reference.

### BACKGROUND OF THE INVENTION

1. Field of the Invention

The present invention relates to a liquid crystal display (“LCD”), and more particularly, to a photoluminescent LCD that improves the contrast of images.

2. Description of the Related Art

A cathode ray tube (“CRT”) monitor has been conventionally used to display data of televisions and computers. In recent years, as a large-sized and slim screen is on an increasing trend, flat panel displays (“FPDs”), such as a liquid crystal display (“LCD”), a plasma display panel (“PDP”), and a field emission display (“FED”), have been utilized. Among the FPDs, the LCD has been popularly adopted for monitors of televisions and computers because it consumes small power.

A conventional LCD is a light-receiving LCD including a color filter that transmits white light modulated by a liquid crystal (“LC”) layer to create desired colored images. Here, the color filter includes red (“R”), green (“G”), and blue (“B”) filters. However, in this light-receiving LCD, since each of the R, G, and B color filters transmits only predetermined colored light, only ⅓ the white light is used to increase a loss of light. Therefore, the conventional light-receiving LCD has a specific technical limit in embodying images with sufficient brightness.

In order to solve the low luminance of the light-receiving LCD, Breddels et al., U.S. Pat. No. 4,830,469 proposed a photoluminescent LCD using phosphors. According to Breddels et al., phosphors are provided on an inner surface of a front substrate and a mercury lamp that emits ultraviolet (“UV”) light with a wavelength of 360-370 nanometers (nm) is used as a light source. However, the UV light with the wavelength of 360-370 nm is partially absorbed into an LC layer, thus reducing the energy of UV light used for excitation of phosphors. Also, the LC layer may be degraded by the absorbed UV light and is very likely to have a shortened span of life.

To overcome the foregoing drawbacks, a novel photoluminescent LCD was taught in U.S. Pat. No. 6,844,903 as shown in FIG. 1.

Referring to FIG. 1, a B light source 34 that emits B light with a wavelength of about 460 nm is used as a backlight unit, and R and G phosphors 40 and 42 are used as phosphors. Thus, the R and G phosphors 40 and 42 are excited by the light emitted by the B light source 34 and emit R and G light in R and G pixel regions, respectively. Also, the light emitted by the B light source 34 is directly emitted as B light in a B pixel region. However, in the foregoing LCD, the R and G phosphors 40 and 42 are excited also by B light contained in ambient visible light. As a result, the R and G phosphors 40 and 42 also emit unnecessary R and G light, thus lowering the contrast of the images.

### BRIEF SUMMARY OF THE INVENTION

An exemplary embodiment provides a photoluminescent liquid crystal display (“LCD”) that can improve the contrast of images.

An exemplary embodiment provides a photoluminescent LCD including a lower substrate and an upper substrate disposed apart from each other opposite each other, a liquid crystal (“LC”) layer interposed between the lower and upper substrates, a backlight unit disposed under the lower substrate and emitting blue (“B”) light, a phosphor layer disposed on the upper substrate and excited by the B light traveling from the backlight unit through the LC layer and the upper substrate and a color filter layer disposed on the phosphor layer and limiting excitement of the R and G phosphors by ambient light to emit light. The phosphor layer includes a red (“R”) phosphor disposed in an R pixel region and a green (“G”) phosphor disposed in a G pixel region. The color filter layer includes an R filter disposed on the R phosphor and a G filter disposed on the G phosphor.

In an exemplary embodiment, the photoluminescent LCD may further include a B pixel region of the phosphor layer directly transmitting the B light traveling from the backlight unit through the LC layer and the upper substrate.

In an exemplary embodiment, a transparent substrate may be further disposed between the phosphor layer and the color filter layer. The transparent substrate may be further disposed on the color filter layer.

In an exemplary embodiment, the backlight may emit the B light with a wavelength of about 420 nanometers (nm) to about 500 nanometers (nm). The backlight may emit the B light with a wavelength of 435 nanometers (nm) to about 470 nanometers (nm). The backlight unit may include a blue light emitting diode (“LED”) or a blue organic light emitting diode (“OLED”).

In an exemplary embodiment, the photoluminescent LCD may further include a B pixel region of the phosphor layer including a diffusion member diffusing and emitting incident light. The color filter layer may further include a B filter disposed on the diffusion member.

An exemplary embodiment provides a photoluminescent LCD including a lower substrate and an upper substrate disposed apart from each other and opposite to each other, an LC layer interposed between the lower and upper substrates, a backlight unit disposed under the lower substrate and emitting B light, a phosphor layer disposed between the LC layer and the upper substrate and excited by the B light traveling from the backlight unit through the LC layer and a color filter layer disposed between the phosphor layer and the upper substrate limiting the R and G phosphors from being excited by ambient light. The phosphor layer includes an R phosphor disposed in an R pixel region and a G phosphor disposed in a G pixel region. The color filter layer includes an R filter disposed on the R phosphor and a G filter disposed on the G phosphor.

An exemplary embodiment provides a photoluminescent liquid crystal display (“LCD”) includes a first substrate and a second substrate disposed apart from each other and opposite to each other, a liquid crystal (“LC”) layer interposed between the first and second substrates, a backlight unit disposed under the first substrate and emitting blue (“B”) light, a phosphor layer disposed on the second substrate and excited by the B light traveling from the backlight unit through the LC layer, a third substrate disposed on the second substrate and a color filter layer disposed on the phosphor layer and limiting excitement of the R and G phosphors by ambient light. The phosphor layer includes a red (“R”) phosphor disposed in an R pixel region and a green (“G”) phosphor disposed in a G pixel region. The color filter layer includes an R filter disposed on the R phosphor and a G filter disposed on the G phosphor

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a conventional photoluminescent LCD of the prior art;

FIG. 2 is a cross sectional view of an exemplary embodiment of a photoluminescent LCD according to the present invention;

FIG. 3 is a cross sectional view of another exemplary embodiment of a photoluminescent LCD;

FIG. 4 is a cross sectional view of another exemplary embodiment of a photoluminescent LCD;

FIG. 5 is a cross sectional view of another exemplary embodiment of a photoluminescent LCD according to the present invention;

FIG. 6 is a cross sectional view of another exemplary embodiment of a photoluminescent LCD; and

FIG. 7 is a cross sectional view of another exemplary embodiment of a photoluminescent LCD according to the present invention.

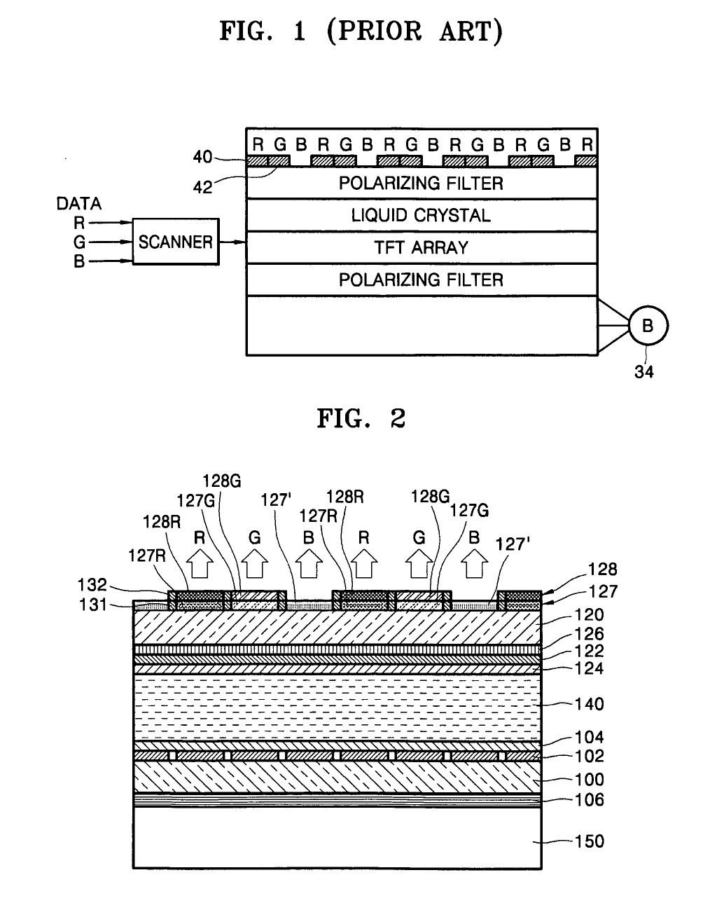

### DETAILED DESCRIPTION OF THE INVENTION

A photoluminescent LCD according to the present invention will now be described more fully hereinafter with reference to the accompanying drawings, in which exemplary embodiments of the invention are shown. The same reference numerals are used to denote the same elements in the drawings.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” other elements or features would then be oriented “above” the other elements or features. Thus, the exemplary term “lower” or “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

FIG. 2 is a cross sectional view of an exemplary embodiment of a photoluminescent LCD according to the present invention.

Referring to FIG. 2, a lower substrate 100 and an upper substrate 120 are disposed a predetermined distance apart from each other and opposite (facing) each other. In an exemplary embodiment, each of the lower substrate 100 and the upper substrate 120 is a transparent glass substrate. A liquid crystal (“LC”) layer 140 is interposed between the lower substrate 100 and the upper substrate 120. The LC layer 140 contains LC molecules, which are arranged in a predetermined direction and switch light emitted by a backlight unit 150 in each pixel when a voltage is applied between the lower substrate 100 and the upper substrate 120.

A lower alignment layer 104 and an upper alignment layer 124 are disposed on bottom and top surfaces of the LC layer 140, respectively. The lower and upper alignment layers 104 and 124 serve to uniformly align the LC molecules in the LC layer 140. In exemplary embodiments, the lower and/or upper alignment layers 104 and 124 may be formed of an inorganic material, such as silicon oxide, magnesium oxide, magnesium fluoride, and gold, or an organic material, such as polyimide and polyvinyl alcohol.

A plurality of lower electrode 102 are positioned between the lower substrate 100 and the lower alignment layer 104 and a plurality of upper electrode 122 are positioned between the upper alignment layer 124 and the upper substrate 120. The lower electrodes 102 and the upper electrodes 122 are considered disposed across from each other. In an exemplary embodiment, the lower electrodes 102 and the upper electrodes 122 may be formed of a transparent conductive material that transmits light. In one exemplary embodiment, the transparent conductive material may include indium tin oxide (“ITO”), tin oxide (“TO”), or indium zinc oxide (“IZO”).

The backlight unit 150 is disposed under the lower substrate 100 as a light source that emits B light toward the LC layer 140. In exemplary embodiments, the backlight unit 150 emits B light with a wavelength of about 420 nm to about 500 nm. In one exemplary embodiment the backlight unit 150 emits B light with a wavelength of about 435 nm to about 470 nm. The backlight unit 150 may be B light emitting diode (“LED”) or a B organic light emitting diode (“OLED”).

A lower polarizer 106 is disposed between the backlight unit 150 and the lower substrate 100. The lower polarizer 106 polarizes B light traveling from the backlight unit 150 to the LC layer 140. An upper polarizer 126 is disposed between the upper electrode 122 and the upper substrate 120. The upper polarizer 126 polarizes B light traveling from the LC layer 140 to the upper substrate 120. In alternative exemplary embodiments, the lower and upper polarizers 106 and 126 may be stacked in different positions from those shown in FIG. 2.

A fluorescent layer 127, such as including phosphor, is disposed on a top surface of the upper substrate 120. The phosphor layer 127 is excited by the B light passing through the LC layer 140 and the upper substrate 120 and emits light. As illustrated in FIG. 2, the phosphor layer 127 contains an R phosphor 127R and a G phosphor 127G that are formed in an R pixel region and a G pixel region, respectively. The R phosphor 127R is excited by the B light passing through the LC layer 140 and the upper substrate 120 and emits R light. The G phosphor 127G is excited by the B light passing through the LC layer 140 and the upper substrate 120 and emits G light.

A B pixel region of the phosphor layer 127 directly transmits the B light that passes through the LC layer 140 and the upper substrate 120. In an exemplary embodiment, the B pixel region of the phosphor layer 127 may be filled with a diffusion member 127′ that diffuses and emits the B light passing through the LC layer 140 and the upper substrate 120. A first black matrix 131 may be disposed between the phosphors of the phosphor layer 127, thus enhancing the contrast property of the LCD.

A color filter layer 128 is disposed on the phosphor layer 127. The color filter layer 128 reduces or effectively prevents the R and G phosphors 127R and 127G of the phosphor layer 127 from being excited by ambient light (especially B light included in the ambient light) to emit light. The color filter layer 128 includes an R filter 128R disposed on the R phosphor 127R and a G filter 128G disposed on the G phosphor 127G. The R filter 128R transmits most of R light “R” (as indicated by the arrow) emitted from the R phosphor 127R but blocks the B light included in the ambient light, so that it can reduce or effectively prevent the R phosphor 127R from being excited by the ambient light to emit light.

Similarly, the G filter 128G transmits most of G light “G” (as indicated by the arrow) emitted from the G phosphor 127G but blocks the B light included in the ambient light, so that it can reduce or effectively prevent the G phosphor 127G from being excited by the ambient light to emit light.

The color filter layer 128 forms a vacant space on the diffusion member 127′ that fills the B pixel region of the phosphor layer 127. As a result, the B light “B” (as indicated by the arrow), which is transmitted through the LC layer 140 and the upper substrate 120, is externally diffused and emitted through the diffusion member 127′. In addition, a second black matrix 132 may be disposed between the color filters of the color filter layer 128 to enhance the contrast property of the LCD. In exemplary embodiments, the color filter layer 128 may be a color filter layer for any of a number of display devices, including but not limited to, LCDs and plasma display panels (“PDPs”).

In exemplary embodiments, the above-described color filter layer 128 may be obtained using a dyeing method, a pigment dispersion method, a screen printing method, an electrode position method, a spin coating method, an inkjet printing method, or any method suitable for the purpose described herein.

In the illustrated embodiment of FIG. 2, B light travels from the backlight unit 150 through the LC layer 140 and the upper substrate 120 and excites the R and G phosphors 127R and 127G of the phosphor layer 127 so that the R and G phosphor layers 127R and 127G emit R and G light “R” and “G”, respectively. The emitted R and G light “R” and “G” pass through the R filter 128R and the G filter 128G of the color filter layer 128 and is mostly externally emitted. Also, the “B” light incident on the diffusion member 127′ of the phosphor layer 127 is diffused and externally emitted. The R and G filters 128R and 128G of the color filter layer 128 block B light included in the ambient light so that they can reduce or effectively prevent the R and G phosphors 127R and 127G of the phosphor layer 127 from being excited by ambient light to emit light. As a result, the LCD can improve the contrast of an image.

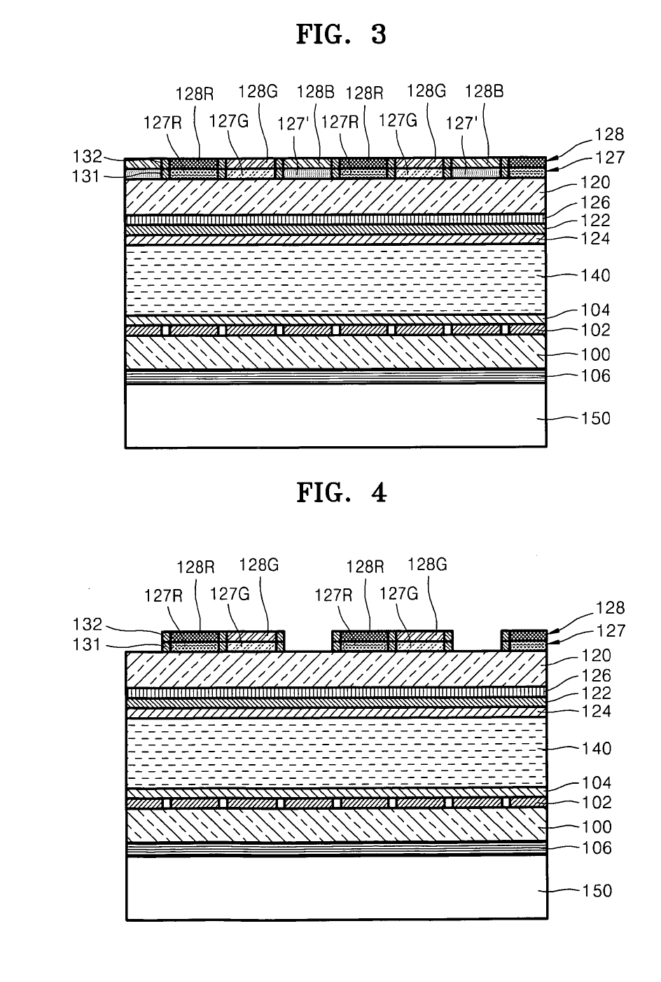

FIG. 3 is a cross sectional view of another exemplary embodiment of a photoluminescent LCD. Referring to FIG. 3, the color filter layer 128 may further include a B filter 128B disposed on the diffusion member 127′ of the phosphor layer 127. In this case, B light “B”, which is incident onto the diffusion member 127′ through the LC layer 140 and the upper substrate 120, is mostly transmitted through the blue filter 128B of the color filter layer 128 and externally emitted.

FIG. 4 is a cross sectional view of another exemplary embodiment of a photoluminescent LCD. Referring to FIG. 4, there is neither the diffusion member 127′ nor the B filter 128B in the B pixel region of the phosphor layer 127. In this case, B light “B,” which is incident onto the B pixel region of the phosphor layer 127 through the LC layer 140 and the upper substrate 120, directly passes through the phosphor layer 127 and the color filter layer 128 and is externally emitted.

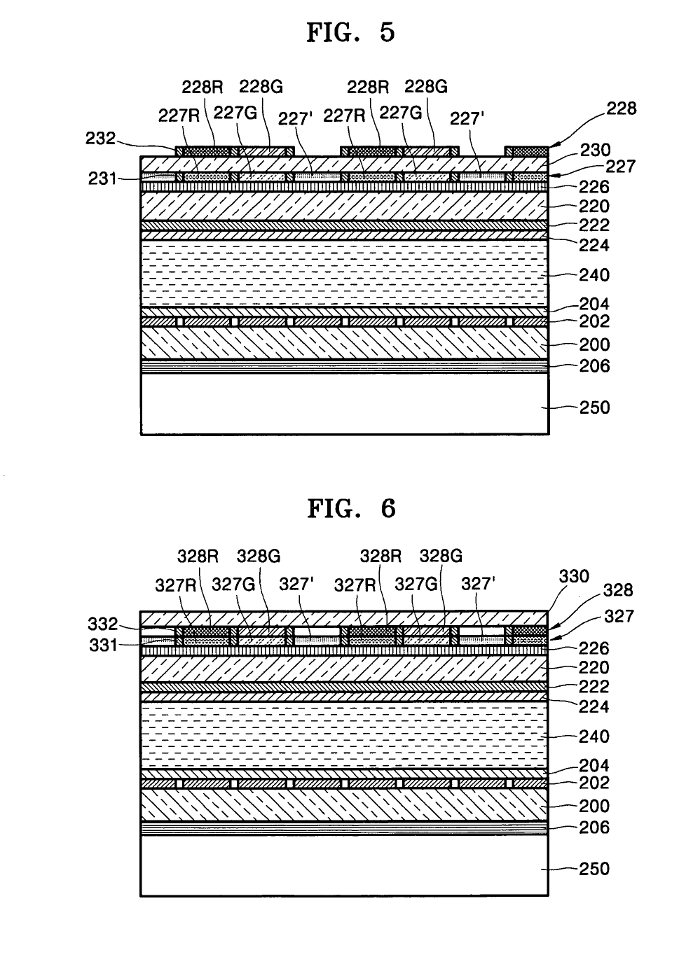

FIG. 5 is a cross sectional view of another exemplary embodiment of a photoluminescent LCD according to the present invention.

Referring to FIG. 5, a lower substrate 200 and an upper substrate 220 are disposed a predetermined distance apart from each other and opposite (facing) each other. An LC layer 240 is interposed between the lower substrate 200 and the upper substrate 220. A lower alignment layer 204 and an upper alignment layer 224 are disposed on bottom and top surfaces of the LC layer 240, respectively. A plurality of lower electrode 202 are positioned between the lower substrate 200 and the lower alignment layer 204 and a plurality of upper electrode 222 are positioned between the upper alignment layer 224 and the upper substrate 220. In an exemplary embodiment, the lower electrodes 202 and the upper electrodes 222 may be formed of a transparent conductive material that transmits light.

A backlight unit 250 is disposed under the lower substrate 200 as a light source that emits B light toward the LC layer 240. In exemplary embodiments, the backlight unit 250 emits the B light with a wavelength of about 420 nm to about 500 nm. In one exemplary embodiment, the backlight unit 250 emits B light with a wavelength of about 435 nm to about 470 nm. The backlight unit 250 may be a blue LED or a blue OLED.

A lower polarizer 206 is disposed between the backlight unit 250 and the lower substrate 200 and an upper polarizer 226 is disposed above the upper substrate 220. In alternative exemplary embodiments, the lower and upper polarizers 206 and/or 226 may be stacked in different positions from those shown in FIG. 5.

A fluorescent layer 227, such as including phosphor, is disposed on a top surface of the upper polarizer 226. The phosphor layer 227 is excited by the B light passing through the LC layer 240 and the upper substrate 220 and emits light. The phosphor layer 227 contains an R phosphor 227R and a G phosphor 227G that are formed in an R pixel region and a G pixel region, respectively. The R phosphor 227R is excited by the B light passing through the LC layer 240 and emits R light. The G phosphor 227G is excited by the B light passing through the LC layer 240 and emits G light.

A B pixel region of the phosphor layer 227 directly transmits the B light “B” that passes through the LC layer 240 and the upper substrate 220. In an exemplary embodiment, the B pixel region of the phosphor layer 227 may be filled with a diffusion member 227′ that diffuses and emits the B light passing through the LC layer 240 and the upper substrate 220. A first black matrix 231 may be disposed between the phosphors of the phosphor layer 227.

A top substrate 230 having a predetermined thickness is disposed on a top surface of the phosphor layer 227. In exemplary embodiments, the top substrate 230 is transparent and may include, but is not limited to, a glass substrate.

A color filter layer 228 is disposed on a top surface of the transparent substrate 230. The color filter layer 228 reduces or effectively prevents the R and G phosphors 227R and 227G of the phosphor layer 227 from being excited by ambient light (especially B light included in the ambient light) to emit light. The color filter layer 228 includes an R filter 228R disposed on the R phosphor 227R and a G filter 228G disposed on the G phosphor 227G. The R filter 228R transmits most of R light “R,” which travels from the R phosphor 227R through the transparent substrate 230, but blocks the B light included in the ambient light, so that it can reduce or effectively prevent the R phosphor 227R from being excited by the ambient light to emit light.

Similarly, the G filter 228G transmits most of G light “G,” which travels from the G phosphor 227G through the transparent substrate 230, but blocks the B light included in the ambient light, so that it can reduce or effectively prevent the G phosphor 227G from being excited by the ambient light to emit light.

The color filter layer 228 forms a vacant space on the diffusion member 227′ that fills the B pixel region of the phosphor layer 227. As a result, the B light “B,” which is incident onto the diffusion member 227′ through the LC layer 240 and the upper substrate 220, is externally emitted through the transparent substrate 230. In an exemplary embodiment, the color filter layer 228 may further include a B filter (not shown) disposed on the diffusion member 227′ of the phosphor layer 227. In addition, a second black matrix 232 may be disposed between the color filters of the color filter layer 228.

FIG. 6 is a cross sectional view of another exemplary embodiment of a photoluminescent LCD. Referring to FIG. 6, a phosphor layer 327 is disposed on the top surface of the upper polarizer 226 and contains an R phosphor 327R and a G phosphor 327G that are disposed in the R pixel region and the G pixel region, respectively. The B pixel region of the phosphor layer 327 may be filled with a diffusion member 327′ that diffuses and emits incident B light.

A color filter layer 328 is disposed on a top surface of the phosphor layer 327. The color filter layer 328 includes an R filter 328R disposed on the R phosphor 327R and a G filter 328G disposed on the G phosphor 327G. In an exemplary embodiment, the color filter layer 328 may further include a blue filter (not shown) disposed on the diffusion member 327′ of the phosphor layer 327.

A transparent substrate 330 having a predetermined thickness is disposed on a top surface of the color filter layer 328. In exemplary embodiments, the transparent substrate 330 may include a glass substrate. In FIG. 6, reference numerals 331 and 332 denote a first black matrix and a second black matrix, respectively.

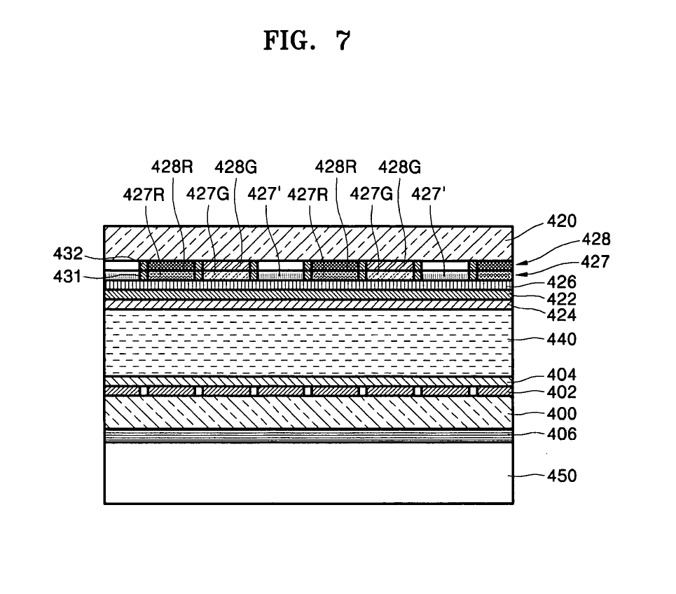

FIG. 7 is a cross sectional view of another exemplary embodiment of a photoluminescent LCD according to the present invention.

Referring to FIG. 7, a lower substrate 400 and an upper substrate 420 are disposed a predetermined distance apart from each other and opposite (facing) each other. An LC layer 440 is interposed between the lower substrate 400 and the upper substrate 420. In an exemplary embodiment, each of the lower substrate 400 and the upper substrate 420 is a transparent glass substrate. A lower alignment layer 404 and an upper alignment layer 424 are disposed on bottom and top surfaces of the LC layer 440, respectively. A plurality of lower electrode 402 are positioned between the lower substrate 400 and the lower alignment layer 404 and a plurality of upper electrode 422 are positioned between the upper alignment layer 424 and the upper substrate 420.

A backlight unit 450 is disposed under the lower substrate 400 as a light source that emits B light toward the LC layer 440. In exemplary embodiments, the backlight unit 450 emits B light with a wavelength of about 420 nm to about 500 nm. In one exemplary embodiment, the backlight unit 450 emits B light with a wavelength of about 435 nm to about 470 nm. The backlight unit 450 may be a blue LED or a blue OLED.

A lower polarizer 406 is disposed between the backlight unit 450 and the lower substrate 400 and an upper polarizer 426 is disposed between the upper electrode 422 and the upper substrate 420. In alternative exemplary embodiments, the lower polarizer 406 and the upper polarizer 426 may be stacked in different positions from those shown in FIG. 7.

A phosphor layer 427 and a color filter layer 428 are disposed between the upper polarizer 426 and the upper substrate 420. The phosphor layer 427 is disposed on a top surface of the upper polarizer 426. The phosphor layer 427 is excited by the B light passing through the LC layer 440 and emits light. The phosphor layer 427 contains an R phosphor 427R and a G phosphor 427G that are formed in an R pixel region and a G pixel region, respectively. In this case, the R phosphor 427R is excited by the B light passing through the LC layer 440 and emits R light. The G phosphor 427G is excited by the B light passing through the LC layer 440 and emits G light. A B pixel region of the phosphor layer 427 directly transmits the B light “B” that passes through the LC layer 440. In this case, the B pixel region of the phosphor layer 427 may be filled with a diffusion member 427′ that diffuses and emits the B light passing through the LC layer 440. A first black matrix 431 may be disposed between the of the phosphor layer 427.

The color filter layer 428 is disposed between the phosphor layer 427 and the upper substrate 420. The color filter layer 428 reduces or effectively prevents the R and G phosphors 427R and 427G of the phosphor layer 427 from being excited by ambient light (especially B light included in the ambient light) to emit light. The color filter layer. 428 includes an R filter 428R disposed on the R phosphor 427R and a G filter 428G disposed on the G phosphor 427G. The R filter 428R transmits most of R light “R” emitted from the R phosphor 427R but blocks the B light included in the ambient light, so that it can reduce or effectively prevent the R phosphor 427R from being excited by the ambient light to emit light.

Similarly, the G filter 428G transmits most of G light “G” emitted from the G phosphor 427G but blocks the B light included in the ambient light, so that it can reduce or effectively prevent the G phosphor 427G from being excited by the ambient light to emit light. The color filter layer 428 forms a vacant space on the diffusion member 427′ that fills the B pixel region of the phosphor layer 427. As a result, the B light “B”, which is incident onto the diffusion member 427′ through the LC layer 440, is externally emitted through the transparent upper substrate 420. In an exemplary embodiment, the color filter layer 428 may further include a B filter (not shown) disposed on the diffusion member 427′ of the phosphor layer 427. A second black matrix 432 may be disposed between the color filters of the color filter layer 428.

In the illustrated embodiments, the photoluminescent LCD includes a color filter layer that blocks B light included in ambient light, thus reducing or effectively preventing R and G phosphors of a phosphor layer from being excited by the ambient light to emit light. Advantageously, the photoluminescent LCD can improve the contrast of images.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A photoluminescent liquid crystal display (“LCD”) comprising:
a lower substrate and an upper substrate disposed apart from each other and opposite to each other;
a liquid crystal (“LC”) layer interposed between the lower and upper substrates;
a backlight unit disposed under the lower substrate and emitting blue (“B”) light;
a phosphor layer disposed on the upper substrate and excited by the B light traveling from the backlight unit through the LC layer and the upper substrate, the phosphor layer including a red (“R”) phosphor disposed in an R pixel region and a green (“G”) phosphor disposed in a G pixel region; and
a color filter layer disposed on the phosphor layer and limiting excitement of the R and G phosphors by ambient light, the color filter layer including an R filter disposed on the R phosphor and a G filter disposed on the G phosphor.

2. The photoluminescent LCD of claim 1, further comprising a B pixel region of the phosphor layer directly transmitting the B light traveling from the backlight unit through the LC layer and the upper substrate.

3. The photoluminescent LCD of claim 1, further comprising a transparent substrate interposed between the phosphor layer and the color filter layer.

4. The photoluminescent LCD of claim 1, further comprising a transparent substrate disposed on the color filter layer.

5. The photoluminescent LCD of claim 1, wherein the backlight emits the B light with a wavelength of about 420 nanometers (nm) to about 500 nanometers (nm).

6. The photoluminescent LCD of claim 5, wherein the backlight emits the B light with a wavelength of about 435 nanometers (nm) to about 470 nanometers (nm).

7. The photoluminescent LCD of claim 1, wherein the backlight unit includes one of a blue light emitting diode (“LED”) and a blue organic light emitting diode (“OLED”).

8. The photoluminescent LCD of claim 1, further comprising a B pixel region of the phosphor layer including a diffusion member diffusing and emitting incident light.

9. The photoluminescent LCD of claim 8, wherein the color filter layer further includes a B filter disposed on the diffusion member.

10. A photoluminescent liquid crystal display (“LCD”) comprising:
a lower substrate and an upper substrate disposed apart from each other and opposite to each other;
a liquid crystal (“LC”) layer interposed between the lower and upper substrates;
a backlight unit disposed under the lower substrate and emitting blue (“B”) light;
a phosphor layer disposed between the LC layer and the upper substrate and excited by the B light traveling from the backlight unit through the LC layer, the phosphor layer including a red (“R”) phosphor disposed in an R pixel region and a green (“G”) phosphor disposed in a G pixel region; and
a color filter layer disposed between the phosphor layer and the upper substrate and limiting excitement of the R and G phosphors by ambient light to emit light, the color filter layer including an R filter disposed on the R phosphor and a G filter disposed on the G phosphor.

11. The photoluminescent LCD of claim 10, further comprising a B pixel region of the phosphor layer directly transmitting the B light traveling from the backlight unit through the LC layer.

12. The photoluminescent LCD of claim 10, wherein the backlight emits the B light with a wavelength of about 420 nanometers (nm) to about 500 nanometers (nm).

13. The photoluminescent LCD of claim 12, wherein the backlight emits the B light with a wavelength of about 435 nanometers (nm) to about 470 nanometers (nm).

14. The photoluminescent LCD of claim 10, wherein the backlight unit includes one of a blue light emitting diode (“LED”) and a blue organic light emitting diode (“OLED”).

15. The photoluminescent LCD of claim 10, further comprising a B pixel region of the phosphor layer and a diffusion member disposed in the B pixel region, the diffusion member diffusing and emitting incident light.

16. The photoluminescent LCD of claim 15, wherein the color filter layer further includes a B filter disposed on the diffusion member.

17. A photoluminescent liquid crystal display (“LCD”) comprising:
a first substrate and a second substrate disposed apart from each other and opposite to each other;
a liquid crystal (“LC”) layer interposed between the first and second substrates;
a backlight unit disposed under the first substrate and emitting blue (“B”) light;
a phosphor layer disposed on the second substrate and excited by the B light traveling from the backlight unit through the LC layer, the phosphor layer including a red (“R”) phosphor disposed in an R pixel region and a green (“G”) phosphor disposed in a G pixel region;
a third substrate disposed on the second substrate; and
a color filter layer disposed on the phosphor layer and limiting excitement of the R and G phosphors by ambient light, the color filter layer including an R filter disposed on the R phosphor and a G filter disposed on the G phosphor.

18. The photoluminescent LCD of claim 17, wherein the color filter layer is disposed between the phosphor layer and the third substrate.

19. The photoluminescent LCD of claim 17, wherein the third substrate is disposed between the phosphor layer and the color filter layer.
